(19) United States
(12) Patent Application Publication
(10) Pub. No.: US 2023/0159028 A1
(43) Pub. Date: May 25, 2023

(54) COLLISION AVOIDANCE ASSISTANCE DEVICE FOR VEHICLE

(71) Applicant: TOYOTA JIDOSHA KABUSHIKI KAISHA, Toyota-shi Aichi (JP)

(72) Inventors: Yusuke FUKUI, Toyota-shi Aichi-ken (JP); Yuhei Miyamoto, Toyota-shi Aich-ken (JP)

(73) Assignee: TOYOTA JIDOSHA KABUSHIKI KAISHA, Toyota-shi Aichi (JP)

(21) Appl. No.: 17/986,164

(22) Filed: Nov. 14, 2022

(30) Foreign Application Priority Data
Nov. 24, 2021 (JP) 2021-190190

(51) Int. Cl. B60W 30/095; B60W 30/09; B60W 50/12

(52) U.S. Cl. CPC B60W 30/0956; B60W 30/09; B60W 50/12; B60W 2540/10

(57) ABSTRACT

A collision avoidance assistance device for a vehicle includes a driving assistance ECU which executes vehicle speed suppression control of suppressing a speed of the vehicle when an obstacle condition indicating that an obstacle exists and an erroneous operation condition indicating that an operation of an accelerator pedal executed is an erroneous operation for a brake pedal are satisfied. The driving assistance ECU inhibits the vehicle speed suppression control in a case in which an avoidance operation condition indicating that a steering operation is an operation for avoiding the collision with the obstacle is satisfied when the vehicle speed is higher than a threshold value, and does not inhibit the vehicle speed suppression control in a case in which the avoidance operation condition is satisfied when the speed of the vehicle is equal to or lower than the threshold value.

### CROSS-REFERENCE TO RELATED APPLICATION

This application claims priority to Japanese Patent Application No. 2021-190190 filed on Nov. 24, 2021, the content of which is hereby incorporated by reference in its entirety into this application

### BACKGROUND

### 1. Technical Field

The present disclosure relates to a collision avoidance assistance device for a vehicle which assists in avoidance of a collision of the vehicle with an obstacle (object).

### 2. Description of the Related Art

Hitherto, there has been known a collision avoidance assistance device for a vehicle which decelerates the vehicle without an operation of a driver of the vehicle when a possibility of a collision of the vehicle with an obstacle becomes higher. For example, a collision avoidance assistance device for a vehicle as described in Japanese Patent Application Laid-open No. 2021-79904 is configured to execute automatic brake control (control of operating a brake without an operation of a brake pedal by a driver of the vehicle) when it is determined that an accelerator pedal is erroneously depressed in a case in which an obstacle with which the vehicle is highly likely to collide is detected. The collision avoidance assistance device for a vehicle as described in Japanese Patent Application Laid-open No. 2021-79904 decelerates the vehicle by the automatic brake control, thereby being capable of assisting in avoiding the collision of the vehicle with the detected obstacle. Further, in Japanese Patent Application Laid-open No. 2021-79904, there is disclosed control of starting the automatic brake control when it is determined that the accelerator pedal is erroneously depressed in the case in which an obstacle with which the vehicle is highly likely to collide is detected, and then stopping the automatic brake control when it is determined that a speed of a steering operation is equal to or higher than a threshold value. With this control, the driver executes a collision avoidance operation for executing the steering operation while depressing the accelerator pedal, thereby being capable of causing the vehicle to travel at a vehicle speed desired by the driver and along a trajectory desired by the driver such that the vehicle does not collide with the obstacle.

However, with the collision avoidance assistance device for a vehicle as described in Japanese Patent Application Laid-open No. 2021-79904, the automatic brake control is finished when the speed of the steering operation is equal to or higher than the threshold value even when the vehicle starts or travels at low speed. When the automatic brake control is finished at the time when the vehicle starts or travels at low speed, there is a fear in that the vehicle may suddenly start or suddenly accelerate from the low speed. Moreover, an operation amount of the accelerator pedal is 0 or substantially 0 when the vehicle starts or travels at low speed. When the operation amount of the accelerator pedal rapidly increases from this state, it is highly likely that an abnormality currently occurs in the driver. Thus, when the automatic brake control is finished in this state, there is a fear in that the vehicle may suddenly start or suddenly accelerate from the low speed despite the abnormality occurring in the driver.

### SUMMARY

The present disclosure has been made to solve the above-mentioned problem, and has an object to provide a collision avoidance assistance device for a vehicle configured to be capable of appropriately avoiding, when an obstacle with which the vehicle is highly likely to collide is detected, a collision with the obstacle.

In order to achieve the above-mentioned object, according to at least one embodiment of the present disclosure, there is provided a collision avoidance assistance device for a vehicle, including: a peripheral information acquisition device configured to acquire object information being information on an object existing in a peripheral region of the vehicle; and a control device configured to: determine whether an obstacle condition indicating that an obstacle with which the vehicle is highly likely to collide exists is satisfied based on the object information acquired by the peripheral information acquisition device; determine whether an erroneous operation condition indicating that a driving force increase operation executed by a driver for increasing a driving force output by a driving force source of the vehicle is an erroneous operation is satisfied and whether an avoidance operation condition indicating that a steering operation for avoiding a collision of the vehicle with the obstacle has been executed is satisfied; execute vehicle speed suppression control of reducing a speed of the vehicle so that the speed is lower than a speed set by the driving force increase operation when the obstacle condition and the erroneous operation condition are determined to be satisfied; inhibit the vehicle speed suppression control in a case in which the avoidance operation condition is satisfied when the speed of the vehicle is higher than a vehicle speed threshold value; and allow the vehicle speed suppression control in a case in which the avoidance operation condition is satisfied when the speed of the vehicle is equal to or lower than the vehicle speed threshold value.

When the driver executes an operation for avoiding the collision between the vehicle and the obstacle during the travel of the vehicle, it is desired that the vehicle travel at a speed intended by the driver along a route intended by the driver to avoid the collision with the obstacle. Thus, the collision avoidance assistance device for a vehicle according to the at least one embodiment of the present disclosure inhibits the vehicle speed suppression control in the case in which it is determined that the driver has executed the operation for avoiding the collision between the vehicle and the obstacle (that is, the case in which the avoidance operation condition is determined to be satisfied) when the vehicle is traveling at a speed higher than the vehicle speed threshold value. “Inhibiting the vehicle speed suppression control” is finishing the vehicle speed suppression control in the case in which the vehicle speed suppression control is being executed, and not starting the vehicle speed suppression control in the case in which the vehicle speed suppression control is not being executed. As a result, the driver can avoid the collision with the obstacle through a driving operation (for example, steering operation and driving force increase operation) of the driver without interference of the vehicle speed suppression control. Meanwhile, when the vehicle speed suppression control is inhibited at the time when the vehicle starts or travels at low speed, there is a fear in that the vehicle may suddenly start or suddenly accelerate from the low speed. Thus, the collision avoidance assistance device for a vehicle according to the at least one embodiment of the present disclosure does not inhibit the vehicle speed suppression control when the vehicle starts or travels at low speed (that is, when the vehicle speed is equal to or lower than the vehicle speed threshold value). Consequently, it is possible to prevent or suppress the sudden start and the sudden acceleration from low speed of the vehicle. Moreover, in the case in which the erroneous operation condition is satisfied when the vehicle speed is equal to or lower than the threshold value, there is a possibility that an abnormality currently occurs in the driver. Thus, in the case in which an abnormality currently occurs in the driver, it is possible to appropriately avoid the collision with an obstacle by not inhibiting the vehicle speed suppression control in this case.

Moreover, according to the at least one embodiment of the present disclosure, there is provided a collision avoidance assistance device for a vehicle, including: a peripheral information acquisition device configured to acquire object information being information on an object existing in a peripheral region of the vehicle; and a control device configured to: determine whether an obstacle condition indicating that an obstacle with which the vehicle is highly likely to collide exists is satisfied based on the object information acquired by the peripheral information acquisition device; determine whether an erroneous operation condition indicating that a driving force increase operation executed by a driver for increasing a driving force output by a driving force source of the vehicle is an erroneous operation is satisfied and whether an avoidance operation condition indicating that a steering operation for avoiding a collision of the vehicle with the obstacle has been executed is satisfied; execute vehicle speed suppression control of reducing a speed of the vehicle so that the speed is lower than a speed set by the driving force increase operation when the obstacle condition and the erroneous operation condition are determined to be satisfied; and inhibit the vehicle speed suppression control when the avoidance operation condition is determined to be satisfied. The control device is configured to determine that the avoidance operation condition is satisfied when the speed of the vehicle is equal to or lower than the vehicle speed threshold value, a part of the obstacle or another obstacle different from the obstacle is detected to exist on one side out of a right outer side and a left outer side of a predicted travel trajectory of the vehicle, and the steering operation is an operation for moving the vehicle to a direction opposite to the one side.

When the steering operation (operation for changing the travel direction of the vehicle) is an operation for causing the vehicle to travel toward the direction opposite to the direction in which the another obstacle exists, this operation is highly likely to be an operation based on an intention of the driver to avoid a collision between the vehicle and the another obstacle. Thus, in this case, the collision with the another obstacle can be avoided by inhibiting the vehicle speed suppression control, to thereby allow the driver to execute a driving operation (for example, a steering operation and a driving force increase operation) of the driver without interference of the vehicle speed suppression control. Meanwhile, when the steering operation is an operation for causing the vehicle to travel toward the same direction as the direction in which the another obstacle exists, there is a possibility that an abnormality currently occurs in the driver. Thus, in the case in which an abnormality currently occurs in the driver, it is possible to appropriately avoid the collision with the obstacle by not inhibiting the vehicle speed suppression control in this case. The “predicted travel trajectory” of the vehicle is a “trajectory through which the vehicle is predicted to pass” when the vehicle travels.

There may be applied a configuration in which the driving force increase operation is an operation for increasing an operation amount of an accelerator pedal, and the control device is configured to determine that the erroneous operation condition is satisfied in a case in which the operation amount of the accelerator pedal is equal to or larger than a threshold value when the speed of the vehicle is equal to or lower than the vehicle speed threshold value.

The case in which the operation amount of the accelerator pedal has become equal to or larger than the threshold value when the vehicle speed is equal to or lower than the vehicle speed threshold value indicates a rapid increase in the operation amount of the accelerator pedal. In this case, there is a high possibility that “the driving force increase operation executed by the driver for increasing the driving force output by the driving force source of the vehicle is an erroneous operation for a deceleration operation for decelerating the vehicle.” Thus, with this configuration, it is possible to increase an effect of preventing or suppressing the sudden start and the sudden acceleration from low speed of the vehicle when the driver erroneously operates the accelerator pedal.

There may be applied a configuration in which the vehicle speed suppression control is control of setting a driving force output by an internal combustion engine being the driving force source of the vehicle to a driving force at idling when the speed of the vehicle is equal to or lower than the vehicle speed threshold value.

With this configuration, reliability of the effect of suppressing the speed of the vehicle can be increased.

There may be applied a configuration in which the vehicle speed suppression control is control of setting the driving force output by the driving force source of the vehicle to a driving force which allows a state in which the vehicle is stopped on an inclined road surface to be maintained when the speed of the vehicle is equal to or lower than the vehicle speed threshold value.

With this configuration, the state in which the vehicle is stopped can be maintained even in the case in which the road surface is inclined. As a result, it is possible to prevent the vehicle from moving on the inclined road surface by the gravity by the execution of the vehicle speed suppression control.

There may be applied a configuration in which the vehicle speed suppression control is control of decelerating the vehicle when the speed of the vehicle is higher than the vehicle speed threshold value.

With this configuration, it is possible to prevent the vehicle from colliding with an obstacle when the vehicle is traveling at a speed higher than the vehicle speed threshold value.

In the description above, in order to facilitate understanding of the disclosure, reference symbols used in embodiments of the present disclosure are enclosed in parentheses, and are assigned to each of constituent features of the disclosure corresponding to the embodiments. However, each of the constituent features of the disclosure is not limited to the embodiments prescribed by the reference symbols.

### BRIEF DESCRIPTION OF THE DRAWINGS

FIG. 1 is a diagram for illustrating a configuration of a collision avoidance assistance device for a vehicle.

FIG. 2 is a diagram for illustrating an example of a positional relationship between the vehicle and an obstacle.

FIG. 3 is a flowchart for illustrating a collision avoidance assistance routine.

FIG. 4 is a flowchart for illustrating a collision avoidance assistance routine.

### DESCRIPTION OF THE EMBODIMENTS

Description is now given of each embodiment of the present disclosure. In the description given below, a collision avoidance assistance device for a vehicle may be abbreviated as “assistance device.”

### First Embodiment

First, description is given of a first embodiment of the present disclosure.

<Device Configuration>

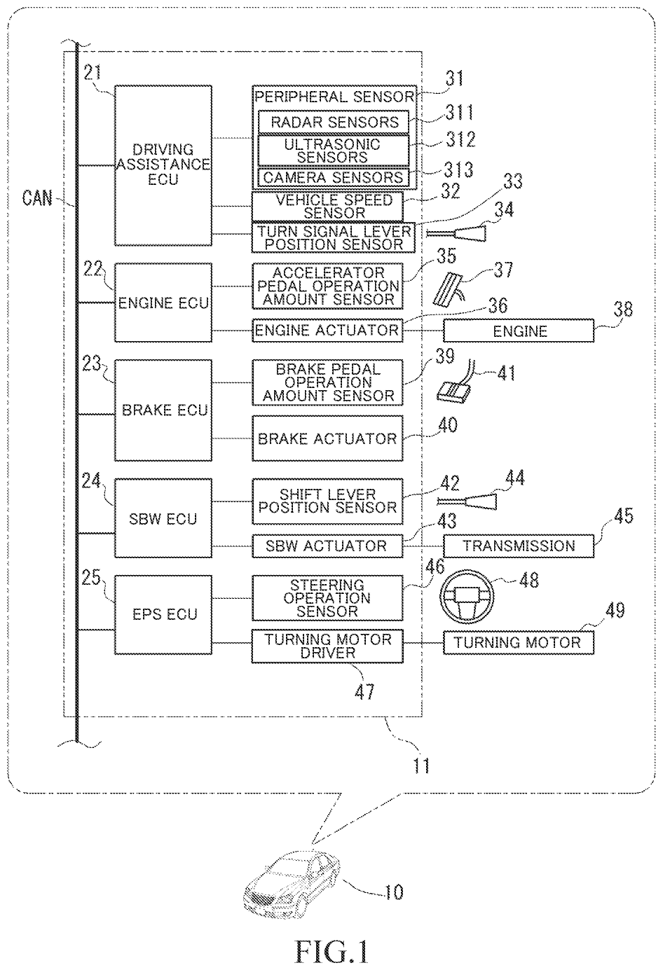

FIG. 1 is a diagram for illustrating a configuration example of an assistance device 11 mounted to a vehicle 10. As illustrated in FIG. 1, the assistance device 11 includes a driving assistance ECU 21, an engine ECU 22, a brake ECU 23, an SBW ECU 24, and an EPS ECU 25. The “ECU” stands for “electric control unit.” Each of those ECUs includes a microcomputer. The microcomputer includes a CPU, a ROM, a RAM, a nonvolatile memory, an interface I/F, and the like. The CPU is configured to execute instructions (programs and routines) stored in the ROM, to thereby achieve various functions. Moreover, those ECUs are connected to one another so that information can be mutually transmitted and received via a controller area network (CAN). Thus, a detection result obtained by a sensor connected to one certain ECU, an operation on a switch connected thereto, and the like can be acquired by another ECU. Some or all of those ECUs may be integrated into one ECU.

The driving assistance ECU 21 is an example of a control device in at least one embodiment of the present disclosure, and is a central device for execution of collision avoidance assistance control described later. To the driving assistance ECU 21, a peripheral sensor 31, a vehicle speed sensor 32, and a turn signal lever position sensor 33 are connected.

The peripheral sensor 31 is an example of a peripheral information acquisition device in the at least one embodiment of the present disclosure. The peripheral sensor 31 is configured to acquire information on objects existing in a peripheral region of the vehicle 10 (range within a predetermined distance from the vehicle 10 in a plan view). The information on the objects may be hereinafter referred to as “object information.” The objects represent, for example, moving objects such as other vehicles (automobiles), pedestrians, and bicycles and fixed objects (buildings and installed objects) such as guard rails and fences. The object information includes information indicating, for example, a distance between the vehicle 10 and the object, a relative speed between the vehicle 10 and the object, and a relative position (direction) of the object with respect to the vehicle 10. The peripheral sensor 31 includes a plurality of radar sensors 311, a plurality of ultrasonic sensors 312, and a plurality of camera sensors 313. In FIG. 1, for the convenience of simplicity, one of the radar sensors 311, one of the ultrasonic sensors 312, and one of the camera sensors 313 are illustrated.

Each radar sensor 311 includes a radar transmission and reception unit and a signal processing unit (which are not shown). The radar transmission and reception unit emits a radio wave in the millimeter wave band (hereinafter referred to as “millimeter wave”) toward the peripheral region of the vehicle 10, and receives a millimeter wave (that is, reflected wave) reflected by an object (for example, another vehicle, a pedestrian, a bicycle, or a building) existing in the peripheral region of the vehicle 10. Moreover, each radar sensor 311 acquires the object information based on a phase difference between the transmitted millimeter wave and the received reflected wave, an attenuation level of the reflected wave, a period of time from the transmission of the millimeter wave to the reception of the reflected wave, or the like. Each radar sensor 311 outputs the acquired object information to the driving assistance ECU 21. The plurality of radar sensors 311 include a front radar sensor and a rear radar sensor. The front radar sensor is provided in a front center portion of a vehicle body, and is configured to search for objects (3D objects) existing in a front region of the vehicle 10 (including diagonally front regions of the vehicle 10). The rear radar sensor is provided in a rear center portion of the vehicle body, and is configured to search for objects existing in a rear region of the vehicle 10 (including diagonally rear regions of the vehicle 10).

Each ultrasonic sensor 312 transmits an ultrasonic wave in a pulse form to the peripheral region of the vehicle 10, and receives a reflected wave reflected by an object. Each ultrasonic sensor 312 acquires object information based on a period of time from the transmission to the reception of the ultrasonic wave. The object information acquired by each ultrasonic sensor 312 includes information indicating, for example, a “reflection point being a point on the object which has reflected the transmitted ultrasonic wave” and a “distance between each ultrasonic sensor 312 and the reflection point.” Each ultrasonic sensor 312 outputs the acquired peripheral information (object information) to the driving assistance ECU 21.

Each camera sensor 313 includes a digital camera incorporating an image pickup element such as a charge coupled device (CCD) or a CMOS image sensor (CIS). The plurality of camera sensors 313 include a front camera sensor which photographs the front region of the vehicle 10 (including the obliquely front regions of the vehicle 10), a rear camera sensor which photographs the rear region of the vehicle 10 (including the obliquely rear regions of the vehicle 10), a right lateral camera sensor which photographs a region on a right side of the vehicle 10 (including a right diagonally front region and a right diagonally rear region of the vehicle 10), and a left lateral camera sensor which photographs a region on a left side of the vehicle 10 (including a left diagonally front region and a left diagonally rear region of the vehicle 10).

The front camera sensor is arranged in an upper portion of a wind shield in a cabin, and photographs a front scenery of the vehicle 10. Moreover, the front camera sensor acquires object information by, for example, searching for an object existing forward of the vehicle 10 and identifying a type of the object based on a taken image, and transmits the acquired object information to the driving assistance ECU 21 at a predetermined cycle. The object information acquired by the front camera includes information indicating the type of the detected object, a size of the object, and a positional relationship of the object with respect to the vehicle 10 (a distance from the vehicle 10 to the object and a direction of the object as viewed from the vehicle 10). To the search for the object and the identification of the type of the object by the front camera, machine learning, for example, pattern matching, is applicable.

The rear camera sensor is arranged in, for example, an upper portion of a rear window in the cabin, and photographs a rear scenery of the vehicle 10. The right lateral camera sensor is provided in a right side mirror, and photographs a scenery on the right side of the vehicle 10. The left lateral camera sensor is provided in a left side mirror, and photographs a scenery on the left side of the vehicle 10. The rear camera sensor, the right lateral camera sensor, and the left lateral camera sensor, as with the front camera sensor, also acquire the object information by searching for objects (3D objects) existing backward of the vehicle 10, rightward of the vehicle 10, and leftward of the vehicle 10, respectively, based on the taken images, and transmit the acquired object information to the driving assistance ECU 21 at the predetermined cycle.

The turn signal lever position sensor 33 is configured to detect a position of a turn signal lever 34, and to transmit information indicating the detected position of the turn signal lever 34 to the driving assistance ECU 21. The turn signal lever 34 is an operation member for selectively operating left and right turn signals. The turn signal lever 34 is configured to be movable to a right ON position for operating the right turn signals, a left ON position for operating the left turn signals, and an OFF position for operating none of the left and right turn signals. The driving assistance ECU 21 can determine whether the left and right turn signals are operating (are flashing) or are not operating (are turned off) based on a detection result of the position of the turn signal lever 34 acquired from the turn signal lever position sensor 33.

To the engine ECU 22, an accelerator pedal operation amount sensor 35 and an engine actuator 36 are connected. The accelerator pedal operation amount sensor 35 detects an operation amount of an accelerator pedal 37, and transmits a signal indicating the detected operation amount of the accelerator pedal 37 to the engine ECU 22. An operation for increasing the operation amount of the accelerator pedal 37 (operation for depressing the accelerator pedal 37) is a “driving force increase operation for increasing a driving force output by a driving force source of the vehicle 10” in the at least one embodiment of the present disclosure. The engine ECU 22 determines a target driving force of an engine 38 based on the operation amount of the accelerator pedal 37 acquired from the accelerator pedal operation amount sensor 35, and controls the engine actuator 36 so that the driving force output by the engine 38 reaches the target driving force. The driving force output by the engine 38 is transmitted to driving wheels via a transmission 45.

When the vehicle 10 is a hybrid vehicle, the engine ECU 22 can control a driving force for the vehicle 10 generated by one or both of “an internal combustion engine and an electric motor (motor)” serving as the driving force source for the travel of the vehicle 10. When the vehicle 10 is an electric vehicle, the engine ECU 22 can control a driving force output by an electric motor serving as the driving force source for the travel of the vehicle 10. When the vehicle 10 is an electric vehicle, the engine actuator 36 in the first embodiment is a drive device for the motor. When the vehicle 10 is a hybrid vehicle, the engine actuator 36 in the first embodiment is an engine actuator and a drive device for the motor.

The driving assistance ECU 21 can transmit a driving force control command including a target driving force of the engine 38 to the engine ECU 22. When the engine ECU 22 receives the driving force control command from the driving assistance ECU 21, the engine ECU 22 automatically (that is, without requiring the operation of the accelerator pedal 37 by the driver and regardless of the operation amount of the accelerator pedal 37 by the driver) controls the engine actuator 36 so that the driving force output by the engine 38 reaches the target driving force included in the received driving force control command.

To the brake ECU 23, a brake pedal operation amount sensor 39 and a brake actuator 40 are connected. The brake pedal operation amount sensor 39 detects an operation amount of a brake pedal 41, and transmits a signal indicating the detected operation amount of the brake pedal 41 to the brake ECU 23. An operation for increasing the operation amount of the brake pedal 41 (operation for depressing the brake pedal 41) is an “operation for decelerating the vehicle 10” in the at least one embodiment of the present disclosure. The brake actuator 40 is provided to a hydraulic circuit arranged between a master cylinder (not shown) which pressurizes working oil through a stepping force of the brake pedal 41 by the driver and friction brake mechanisms provided on left and right front wheels and left and right rear wheels. The friction brake mechanisms each include a brake disc fixed to a wheel and a brake caliper fixed to the vehicle body. The brake actuator 40 adjusts a hydraulic pressure of oil supplied to a wheel cylinder integrated into each brake caliper in response to a command from the brake ECU 23, and operates the wheel cylinder through the hydraulic pressure to press brake pads against the brake disc, to thereby generate a friction braking force. The brake ECU 23 sets a target deceleration of the vehicle 10 based on the operation amount of the brake pedal 41 detected by the brake pedal operation amount sensor 39, and controls the brake actuator 40 so that the vehicle 10 decelerates at the set target deceleration.

The driving assistance ECU 21 can transmit a braking control command including a target deceleration of the vehicle 10 to the brake ECU 23. When the engine ECU 22 receives the braking control command from the driving assistance ECU 21, the engine ECU 22 automatically (that is, without requiring the operation of the brake pedal 41 by the driver and regardless of the operation amount of the brake pedal 41 by the driver) controls the brake actuator 40 so that the deceleration of the vehicle 10 reaches the target deceleration included in the received braking control command.

To the SBW ECU 24, a shift lever position sensor 42 and an SBW actuator 43 are connected. The shift lever position senor 42 detects a position of a shift lever 44 being an operation member operated by the driver to switch a shift position of the transmission 45, and transmits a signal indicating the detected position of the shift lever 44 to the SBW ECU 24. The SBW ECU 24 controls the SBW actuator 43 based on the acquired position of the shift lever 44 to switch a shift range of the transmission 45 to a shift range corresponding to the position of the shift lever 44. The positions of the shift lever 44 (shift range of the transmission 45) includes positions (shift ranges) for moving the vehicle 10 forward and a position (shift range) for moving the vehicle 10 backward. The positions (shift ranges) for moving the vehicle 10 forward include, for example, a “D position (D range),” an “S position (S range),” and a “B position (B range).” The position (shift range) for moving the vehicle 10 backward is an “R position (R range).”

The EPS ECU 25 is an electronic control unit of a well-known electric power steering system. To the EPS ECU 25, a steering operation sensor 46 and a turning motor driver 47 are connected. The steering operation sensor 46 detects an operation direction (steering direction) and an operation amount (steering angle) of a steering wheel 48, and transmits a signal indicating the detected operation direction and operation amount of the steering wheel 48 to the EPS ECU 25. The turning motor driver 47 can change a steering angle (also referred to as “turning angle” or “turn angle”) of the vehicle 10 by controlling a turning motor 49. The EPS ECU 25 controls the turning motor driver 47 based on the operation direction and the operation amount of the steering wheel 48 acquired by the steering operation sensor 46 to apply a steering torque (steering assist torque) to a steering mechanism (not shown), thereby being capable of assisting in the steering operation of the driver.

<Collision Avoidance Assistance Control>

Description is now given of the collision avoidance assistance control. In the description given below, an “object with which a collision or a contact should be avoided” may be referred to as “obstacle.” The obstacles include, for example, another vehicle, a pedestrian, a bicycle, a guard rail, a fence, a wall, and a utility pole, and do not include a road stud (stop line stud) provided to a stop line. Moreover, in the following description, the operation amount of the accelerator pedal 37 is indicated as a ratio (%) to the maximum operation amount.

The collision avoidance assistance control in the first embodiment includes “control of suppressing the vehicle speed regardless of the operation amount of the accelerator pedal 37 when, immediately after a start of the vehicle 10 or during low speed travel (for example, during a slow travel) of the vehicle 10, an obstacle with which the vehicle 10 is highly likely to collide is detected, and the driver intends to operate the brake pedal 41, but the driver increases the operation amount of the accelerator pedal 37 (depresses the accelerator pedal 37), that is, the driving force increase operation for increasing the driving force of the vehicle 10 is an erroneous operation” and “control of decelerating the vehicle 10 when, during a travel of the vehicle 10 at a predetermined speed or higher, an obstacle with which the vehicle 10 is highly likely to collide is detected, and the driver intends to operate the brake pedal 41, but the driver increases the operation amount of the accelerator pedal 37 (the driving force increase operation is an erroneous operation).” “Suppressing the vehicle speed” means decreasing an actual vehicle speed to a speed lower than a vehicle speed set based on the operation amount of the accelerator pedal 37. Thus, “suppressing the vehicle speed” includes “inhibiting an increase in vehicle speed to the vehicle speed set based on the operation amount of the accelerator pedal 37 when the vehicle speed is lower than the speed set based on the operation amount of the accelerator pedal 37” and “decelerating the vehicle speed to a vehicle speed lower than the vehicle speed set based on the operation amount of the accelerator pedal 37.” The “control of suppressing the vehicle speed regardless of the vehicle speed set based on the operation amount of the accelerator pedal 37” being a part of the collision avoidance assistance control is hereinafter referred to as “vehicle speed suppression control.”

“When, immediately after the start of the vehicle 10 or during the low speed travel of the vehicle 10, an obstacle with which the vehicle 10 is highly likely to collide is detected, and the driver intends to operate the brake pedal 41, but the driver increases the operation amount of the accelerator pedal 37” is, for example, “a case in which the driver finds an obstacle existing in a travel direction of the vehicle 10 when the driver is to depress the accelerator pedal 37, or immediately after the driver starts to depress the accelerator pedal 37, and hence the driver is to depress the brake pedal 41 in order to stop or decelerate the vehicle 10, but erroneously depresses the accelerator pedal 37.” The “obstacle with which the vehicle 10 is highly likely to collide or contact” may be hereinafter referred to as “marked obstacle.” Moreover, “having an intention to depress the brake pedal 41 in order to stop or decelerate the vehicle 10, but erroneously depressing the accelerator pedal 37 (increasing the operation amount of the accelerator pedal 37)” may be referred to as “erroneous operation of the accelerator pedal 37.”

The driving assistance ECU 21 determines whether or not a vehicle speed condition being a condition indicating that the vehicle 10 has started immediately before or is traveling at low speed is satisfied. Moreover, the driving assistance ECU 21 determines whether or not an obstacle condition indicating that a marked obstacle exists is satisfied and whether or not an erroneous operation condition indicating that the driver erroneously operates the accelerator pedal 37 is satisfied. Further, the driving assistance ECU 21 executes the vehicle speed suppression control when both of the obstacle condition and the erroneous operation condition are satisfied. The vehicle speed suppression control varies between the case in which the vehicle speed condition is satisfied and the case in which the vehicle speed condition is not satisfied. The vehicle speed suppression control at the time when the vehicle speed condition is satisfied is control (hereinafter referred to as “driving force suppression control”) of reducing the driving force output by the engine 38 to a predetermined driving force. The vehicle speed suppression control at the time when the vehicle speed condition is not satisfied is control (hereinafter referred to as “deceleration control”) of decelerating the vehicle 10.

Further, the driving assistance ECU 21 determines whether or not an avoidance operation condition is satisfied. The avoidance operation condition is a condition indicating that the driver has executed the operation of the steering wheel 48 (the operation of the steering wheel 48 may be hereinafter referred to as “steering operation”) in order to avoid an obstacle. After that, the driving assistance ECU 21 inhibits the execution of the vehicle speed suppression control (deceleration control) even when both of the obstacle condition and the erroneous operation condition are satisfied in the case in which the avoidance operation condition is satisfied when the vehicle speed condition is not satisfied. Meanwhile, the driving assistance ECU 21 does not inhibit the execution of the vehicle speed suppression control (driving force suppression control) in the case in which the avoidance operation condition is satisfied when the vehicle speed condition is satisfied. That is, the driving assistance ECU 21 inhibits the deceleration control in a case in which both of the obstacle condition and the erroneous operation condition are satisfied, but the avoidance operation condition is satisfied when the vehicle 10 has not started immediately before or is not traveling at low speed. Moreover, the driving assistance ECU 21 does not inhibit the driving force suppression control even when the avoidance operation condition is satisfied as long as both of the obstacle condition and the erroneous operation condition are satisfied in the case in which the vehicle 10 has started immediately before or is traveling at low speed. “Inhibiting the vehicle speed suppression control” means finishing the vehicle speed suppression control when the vehicle speed suppression control is being executed, and not executing (not starting) the vehicle speed suppression control when the vehicle speed suppression control is not being executed.

(Vehicle Speed Condition)

The vehicle speed condition is a condition indicating that the vehicle 10 has started immediately before or is traveling at low speed. Specifically, the vehicle speed condition is a condition satisfied when an absolute value of the vehicle speed is equal to or smaller than a threshold value. “The absolute value of the vehicle speed is equal to or smaller than the threshold value” includes a case in which the vehicle speed is 0 km/h. Thus, it can also be considered that the “case in which the vehicle speed condition is satisfied” is a case in which the vehicle 10 is traveling at a vehicle speed equal to or lower than the threshold value or a case in which the vehicle 10 is stopped, and a “case in which the vehicle speed condition is not satisfied” is a case in which the vehicle 10 is traveling at a vehicle speed higher than the threshold value (case in which the absolute value of the vehicle speed is larger than the threshold value). This threshold value is hereinafter referred to as “vehicle speed threshold value.” A specific value of the vehicle speed threshold value is not particularly limited, but is a value other than 0 km/h, and for example, 15 km/h is applied.

(Obstacle Condition)

The obstacle condition is a condition indicating that a marked obstacle exists. The obstacle condition varies between the case in which the vehicle speed condition is satisfied and the case in which the vehicle speed condition is not satisfied. The obstacle condition in the case in which the vehicle speed condition is satisfied is referred to as “first obstacle condition” and the obstacle condition in the case in which the vehicle speed condition is not satisfied is referred to as “second obstacle condition” in order to discriminate those obstacle conditions from each other.

(First Obstacle Condition)

The first obstacle condition is a condition for determining whether or not a detected obstacle is a marked obstacle when the vehicle speed condition is satisfied. The first obstacle condition is satisfied when an obstacle is within a range of an estimated travel trajectory of the vehicle 10, and exists forward of the vehicle 10 within a predetermined distance from a front end of the vehicle 10 in a case in which the position of the shift lever 44 (shift range of the transmission 45) is at the position (shift range) for moving forward the vehicle 10. Moreover, the first obstacle condition is satisfied when an obstacle is within a range of an estimated travel trajectory of the vehicle 10, and exists backward of the vehicle 10 within a predetermined distance from a rear end of the vehicle 10 in a case in which the position of the shift lever 44 (shift range of the transmission 45) is at the position (shift range) for moving backward the vehicle 10. The “predetermined distance” is not particularly limited, and for example, a distance of 5 m is applicable. The “predicted travel trajectory” of the vehicle 10 means a “trajectory through which the vehicle 10 is predicted to pass” when the vehicle 10 travels.

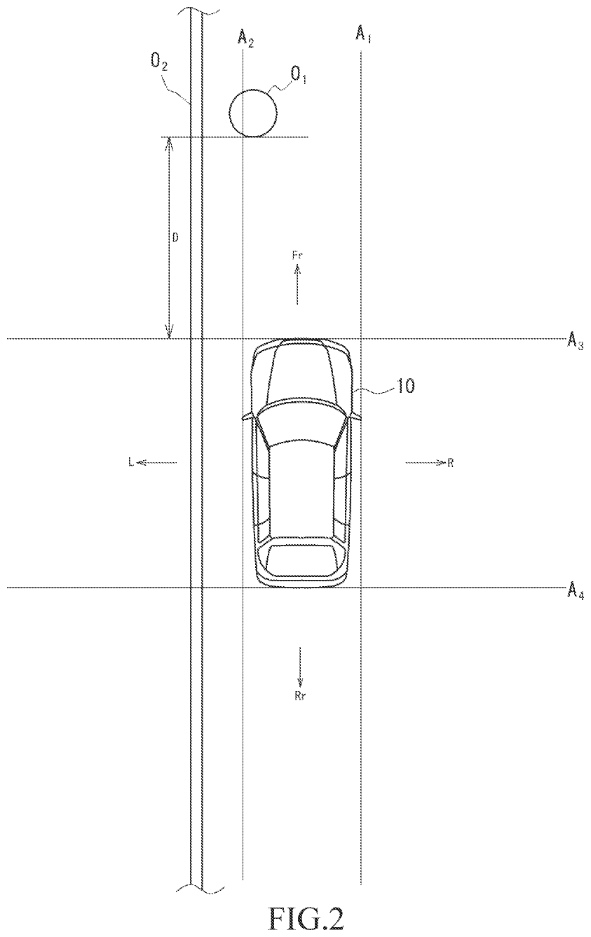

FIG. 2 is a diagram for illustrating an example of a positional relationship between the vehicle 10 and an object (obstacle). In FIG. 2, the front side of the vehicle 10 is indicated by an arrow Fr. The rear side of the vehicle 10 is indicated by an arrow Rr. The right side of the vehicle 10 is indicated by an arrow R. The left side of the vehicle 10 is indicated by an arrow L. The predicted travel trajectory of the vehicle 10 in the case in which the vehicle 10 moves forward is, of a range between a line A₁ which passes through a right end of the vehicle 10 and is parallel with a front-rear direction of the vehicle 10 and a line A₂ which passes through a left end of the vehicle 10 and is parallel with the front-rear direction of the vehicle 10, a range on a front side of a line A₃ which passes through the front end of the vehicle 10 and is parallel with a right-left direction of the vehicle 10. The predicted travel trajectory of the vehicle 10 in the case in which the vehicle 10 moves backward is, of the range between the line A₁ and the line A₂, a range on the rear side of a line A₄ which passes through a rear end of the vehicle 10 and is parallel with the right-left direction of the vehicle 10. A range of the predicted travel trajectory in a height direction is a range, for example, from a road surface to the highest position (for example, a top surface of a roof) of the vehicle 10. The predicted travel trajectory of the vehicle 10 in the case in which the vehicle 10 moves forward is sometimes referred to as “forward movement trajectory,” and the predicted travel trajectory of the vehicle 10 in the case in which the vehicle 10 moves backward is sometimes referred to as “backward movement trajectory.” The predicted travel trajectory of the vehicle 10 can be determined by a well-known method, for example, based on the position of the shift lever 44 and a detection result of the camera sensors 313.

The driving assistance ECU 21 determines whether or not the first obstacle condition is satisfied based on the detection result of the position of the shift lever 44 detected by the shift lever position sensor 42 and the object information acquired from the peripheral sensor 31. In FIG. 2, there is illustrated an example in which an object O₁ (for example, a bicycle) partially inside the predicted travel trajectory of the vehicle 10 exists forward of the vehicle 10, and an object O₂ (for example, a guard rail) exists on the left side of the vehicle 10. Both of the object O₁ (bicycle) and the object O₂ (guard rail) are obstacles. When the position of the shift lever 44 is the position for moving forward the vehicle 10, and a distance D from the front end of the vehicle 10 to a position of the object O₁ at least partially inside the range of the forward movement trajectory that is the closest to the vehicle 10 is equal to or shorter than a predetermined threshold value, the driving assistance ECU 21 determines that the obstacle O₁ is a marked obstacle, and determines that the first obstacle condition is satisfied. However, in FIG. 2, the object O₂ exists outside the predicted travel trajectory of the vehicle 10, and hence the driving assistance ECU 21 does not determine that this object O₂ is a marked obstacle.

(Second Obstacle Condition)

The second obstacle condition is a condition for determining whether or not a detected obstacle is a marked obstacle when the vehicle speed condition is not satisfied. When an obstacle is detected, the driving assistance ECU 21 determines whether or not the obstacle exists within the range of the predicted travel trajectory of the vehicle 10 (forward movement trajectory when the vehicle 10 travels forward and backward movement trajectory when the vehicle 10 travels backward). Further, when the driving assistance ECU 21 determines that this obstacle exists within the range of the predicted travel trajectory of the vehicle 10, the driving assistance ECU 21 calculates a period of time until the front end or the rear end of the vehicle 10 comes in contact with this obstacle based on the “distance from the vehicle 10 to the obstacle” included in the object information on this obstacle and the vehicle speed acquired from the vehicle speed sensor 32. This period of time is hereinafter referred to as “predicted time to collision.” As the predicted time to collision becomes shorter, it is considered that a possibility of the collision or the contact of the vehicle 10 with the obstacle becomes higher. After that, when the obstacle exists within the range of the predicted travel trajectory of the vehicle 10, and the predicted time to collision is equal to or shorter than a threshold value (hereinafter referred to as “first time threshold value”), the driving assistance ECU 21 determines that this obstacle is a marked obstacle, and determines that the second obstacle condition is satisfied. A specific value of the first time threshold value is not particularly limited. Moreover, the first time threshold value is registered in advance in the driving assistance ECU 21.

(Erroneous Operation Condition)

The erroneous operation condition is a condition satisfied when the driver erroneously operates the accelerator pedal 37 (more accurately, when it is determined that a state in which the driver can be considered to erroneously operate the accelerator pedal 37 has occurred). The erroneous operation condition in the case in which the vehicle speed condition is satisfied is referred to as “first erroneous operation condition” and the erroneous operation condition in the case in which the vehicle speed condition is not satisfied is referred to as “second erroneous operation condition” in order to discriminate those erroneous operation conditions from each other.

(First Erroneous Operation Condition)

The first erroneous operation condition is a condition for determining whether or not the accelerator pedal 37 is erroneously operated when the vehicle speed condition is satisfied. The driving assistance ECU 21 determines that the first erroneous operation condition is satisfied when the following condition A1 is satisfied.

Condition A1: The operation amount of the accelerator pedal 37 is equal to or larger than a first operation amount threshold value. The first operation amount threshold value is a value larger than a fourth operation amount threshold value described later. The driving assistance ECU 21 may determine that the first erroneous operation condition is satisfied when the following condition A2 is satisfied in addition to the above-mentioned condition A1 (that is, both of the condition A1 and the condition A2 are satisfied).

Condition A2: An operation speed of the accelerator pedal 37 at the time when the accelerator pedal 37 is operated is equal to or higher than a first operation speed threshold value.

The operation speed of the accelerator pedal 37 is a change in operation amount of the accelerator pedal 37 per unit time, and is calculated by time differentiation of the operation amount of the accelerator pedal 37.

In the first embodiment, when the operation amount of the accelerator pedal 37 has become equal to or larger than the first operation amount threshold value, it is determined that the accelerator pedal 37 is erroneously operated. That is, when the operation amount of the accelerator pedal 37 has become equal to or larger than the first operation amount threshold value in the case in which the vehicle speed is equal to or lower than the vehicle threshold value, it is indicated that the operation amount of the accelerator pedal 37 has rapidly increased. In this case, the accelerator pedal 37 is highly likely to be erroneously operated (driving force increase operation executed by the driver to increase the driving force output by the driving force source of the vehicle 10 is highly likely to be an erroneous operation for a deceleration operation for decelerating the vehicle 10). Thus, with this configuration, it is possible to highly accurately determine whether or not the driver has erroneously operated the accelerator pedal 37. The first operation amount threshold value of the condition A1 is a threshold value for determining whether or not the operation of the accelerator pedal 37 is an erroneous operation. This threshold value is set to such a value that the driving assistance ECU 21 can detect a rapid depressing operation (rapid increase in operation amount) of the accelerator pedal 37. A specific value of this threshold value is not limited, and is appropriately set.

Moreover, as described above, when the operation amount of the accelerator pedal 37 rapidly increases to become equal to or larger than a predetermined operation amount, it may be determined that the accelerator pedal 37 is erroneously operated. The “operation speed of the accelerator pedal 37 at the time when the accelerator pedal 37 is operated” of the condition A2 is, for example, an “operation speed of the accelerator pedal 37 at a time point when the operation amount of the accelerator pedal 37 reaches the first operation amount threshold value from an operation amount smaller than the first operation amount threshold value.” In this case, the first operation speed threshold value of the condition A2 as well as the first operation amount threshold value of the condition A1 is a threshold value for determining whether or not the operation of the accelerator pedal 37 is an erroneous operation. Moreover, the “operation speed of the accelerator pedal 37 at the time when the accelerator pedal 37 is operated” may be an “average value of the operation speed of the accelerator pedal 37 in a predetermined period including a time point at which the operation amount of the accelerator pedal 37 reaches the first operation amount threshold value from an operation amount smaller than the first operation amount threshold value.” In this case, the “predetermined period” may be, for example, a “period from a time 0.5 second before the ‘time point at which the operation amount of the accelerator pedal 37 reaches the first operation amount threshold value from an operation amount smaller than the first operation amount threshold value’ to the ‘time point at which the operation amount of the accelerator pedal 37 reaches the first operation amount threshold value from an operation amount smaller than the first operation amount threshold value’” or a “period of 0.5 second centered around the ‘time point at which the operation amount of the accelerator pedal 37 reaches the first operation amount threshold value from an operation amount smaller than the first operation amount threshold value.’” Moreover, this predetermined period may be a “period from later one of a ‘time point at which the first obstacle condition is satisfied’ and an ‘operation start time point of the accelerator pedal 37 (time point at which the operation amount of the accelerator pedal 37 becomes no longer 0%)’ to the ‘time point at which the operation amount of the accelerator pedal 37 reaches the first operation amount threshold value from an operation amount smaller than the first operation amount threshold value.’”

(Second Erroneous Operation Condition)

The second erroneous operation condition is a condition for determining whether or not the accelerator pedal 37 is erroneously operated when the vehicle speed condition is not satisfied. The driving assistance ECU 21 determines that the second erroneous operation condition is satisfied when both of a condition B1 and a condition B2 described below are satisfied.

Condition B1: All of the following conditions B1-1 to B1-4 are satisfied.
Condition B1-1: The operation amount of the accelerator pedal 37 is equal to or larger than a second operation amount threshold value.
Condition B1-2: The operation speed of the accelerator pedal 37 is equal to or higher than a second operation speed threshold value.
Condition B1-3: A duration in which the brake pedal 41 is not operated is equal to or longer than a threshold value.
Condition B1-4: A duration in which the turn signals are not operating is equal to or longer than a threshold value.

Condition B2: The operation amount of the accelerator pedal 37 has become equal to or larger than a third operation amount threshold value within a predetermined elapsed time (for example, within 0.5 second) since a time point at which the condition B1 was satisfied. The third operation amount threshold value is a value larger than the second operation amount threshold value.

The second operation amount threshold value is a threshold value for the operation amount of the accelerator pedal 37 for determining whether or not the operation of the accelerator pedal 37 is an erroneous operation. The second operation speed threshold value is a threshold value for the operation speed of the accelerator pedal 37 for determining whether or not the operation of the accelerator pedal 37 is an erroneous operation. Those threshold values are set to such values that a rapid operation (depression operation) of the accelerator pedal 37 can be detected. Thus, the driving assistance ECU 21 can determine whether or not the driver has rapidly operated the accelerator pedal 37 by determining whether or not the condition B1-1 and the condition B1-2 are satisfied. The second operation amount threshold value corresponds to the first operation amount threshold value. The second operation speed threshold value corresponds to the first operation speed threshold value. The first operation amount threshold value and the second operation amount threshold value may be the same values, or may be values different from each other. Similarly, the first operation speed threshold value and the second operation speed threshold value may be the same values, or may be values different from each other.

The condition B1-3 is a condition relating to a period of time in which a state in which the operation of the brake pedal 41 has not been executed since a time point at which the driver finished the operation of the brake pedal 41 continues. For example, under a state in which the driver has not operated the brake pedal 41 for a long period of time, there is a possibility that the driver cannot accurately distinguish a position of the accelerator pedal 37 and a position of the brake pedal 41 from each other. That is, when the condition B1-1 and the condition B1-2 are satisfied under the state in which the elapsed time since the time point at which the driver finished the operation of the brake pedal 41 is long, the operation of the accelerator pedal 37 is highly likely to be an erroneous operation. For this reason, the condition B1-3 is provided.

Condition B1-4 is a condition relating to the duration in which the turn signals are not operating. For example, the vehicle 10 is highly likely to be overtaking a preceding vehicle or the vehicle 10 is highly likely to be traveling on a curve immediately after a time point at which a state (flashing state) in which any one of the left and right turn signals are operating changes to a state (turned-off state) in which none of the left and right turn signals are operating. Under this state, it is highly likely that the driver has intentionally increased the operation amount of the accelerator pedal 37. Meanwhile, when the condition B2-1 and the condition B2-2 are satisfied under the state in which a long period of time has elapsed since the time point at which the operation of the turn signals was finished, the operation of the accelerator pedal 37 is highly likely to be an erroneous operation. For this reason, the condition B1-4 is provided.

The condition B2 is a condition for determining whether or not the operation amount of the accelerator pedal 37 has further increased to become equal to or larger than the third operation amount threshold value within the predetermined period of time since the time point at which the condition B1 was satisfied. When the driver erroneously operates the accelerator pedal 37, the operation amount of the accelerator pedal 37 increases even after the operation amount of the accelerator pedal 37 reaches a value equal to or larger than the second operation amount threshold value (even after the condition B1-2 is satisfied). It is considered that occurrence of this phenomenon is caused by a state in which the driver falls into a panic state and consequently depresses the accelerator pedal 37 hard. Thus, this condition B2 is used to determine whether or not the operation amount of the accelerator pedal 37 is equal to or larger than the third operation amount threshold value, and the satisfaction of this condition B2 is added to the requirements for satisfying the second erroneous operation condition, thereby being capable of more accurately determining the erroneous operation of the accelerator pedal 37.

(Driving Force Suppression Control)

When the driving assistance ECU 21 determines that all of the vehicle speed condition, the first obstacle condition, and the first erroneous operation condition are satisfied, the driving assistance ECU 21 executes the driving force suppression control being the vehicle speed suppression control. The driving force suppression control can also be considered as “control of preventing or suppressing an increase in vehicle speed regardless of the operation amount of the accelerator pedal 37.”

When the vehicle speed condition, the first obstacle condition, and the first erroneous operation condition are satisfied, the driving assistance ECU 21 transmits, to the engine ECU 22, the driving force control command including the target driving force of the engine 38. When the engine ECU 22 receives the driving force control command from the driving assistance ECU 21, the engine ECU 22 controls the engine actuator 36 so that the driving force output by the engine 38 reaches the target driving force included in the driving force control command regardless of the operation amount of the accelerator pedal 37. The target driving force in the driving force suppression control is set to a driving force at the time of, for example, idling (in other words, a driving force at the time when the operation amount of the accelerator pedal 37 is 0%). Moreover, when the vehicle 10 is an electric vehicle or a hybrid vehicle, the target driving force in the driving force suppression control is set to “0.” The target driving force in the driving force suppression control is registered in advance in the driving assistance ECU 21.

However, the target driving force in the driving force suppression control is not limited to the driving force at the time of the idling, and may be larger than the driving force at the time of the idling. For example, the target driving force may be a driving force that can maintain the stop of the vehicle 10 (driving force required to prevent the vehicle 10 from moving by the gravity) when the road surface is inclined. In this case, this target driving force is not required to be a fixed value, and may be changed in accordance with a magnitude of the inclination of the road surface. Specifically, it is only required for the assistance device 11 to include an inclination sensor capable of detecting the inclination of the road surface or an acceleration sensor capable of detecting an acceleration of the vehicle 10. Moreover, the driving assistance ECU 21 calculates the driving force capable of maintaining the stop of the vehicle 10 (driving force capable of preventing the vehicle 10 from descending the inclination by the gravity) based on the inclination of the road surface detected by the inclination sensor or the inclination of the road surface calculated from the acceleration of the vehicle 10 detected by the acceleration sensor. After that, the driving assistance ECU 21 transmits, to the engine ECU 22, the driving force control command having the calculated driving force as the target driving force. When the target driving force is set as described above, even when the road surface is inclined, the stop of the vehicle 10 can be maintained. Thus, it is possible to prevent the vehicle 10 from moving on the inclined road surface by the gravity by the execution of the vehicle speed suppression control. In this case, based on the detection result of the position of the shift lever obtained by the shift lever position sensor 42, the driving assistance ECU 21 may set the target driving force to a driving force that can maintain the stop of the vehicle 10 when the inclination of the road surface is an uphill inclination toward the travel direction, and may set the target driving force to a driving force at the time of the idling when the inclination of the road surface is a downhill inclination toward the travel direction.

(Driving Force Suppression Finish Condition)

A driving force suppression finish condition is a condition for finishing the driving force suppression control. When the driving assistance ECU 21 detects that the operation amount of the accelerator pedal 37 during the execution of the driving force suppression control has become equal to or smaller than the fourth operation amount threshold value, the driving assistance ECU 21 determines that the driving force suppression finish condition is satisfied. The fourth operation amount threshold value is a value larger than such an operation amount that the target driving force in the driving force suppression control can be obtained (0% or such an operation amount that the driving force required to prevent the vehicle 10 from moving by the gravity can be obtained), and smaller than the first operation amount threshold value. To the fourth operation amount threshold value, for example, 30% is applicable. However, a specific value of the fourth operation amount threshold value is not limited, and can appropriately be set to a “value which cannot be considered as an erroneous operation of the accelerator pedal 37 (or which can be considered as a value at the time when an erroneous operation is stopped).” After that, when the driving assistance ECU 21 determines that the driving force suppression finish condition is satisfied, the driving assistance ECU 21 finishes the driving force suppression control. After the end of the driving force suppression control, the engine ECU 22 controls the driving force of the engine 38 based on the operation amount of the accelerator pedal 37.

(Deceleration Control)

When the driving assistance ECU 21 determines that the second obstacle condition and the second erroneous operation condition are satisfied while the vehicle speed condition is not satisfied, the driving assistance ECU 21 executes the deceleration control being the vehicle speed suppression control. The deceleration control is a part of the collision avoidance assistance control, and is control of automatically decelerating the vehicle 10 regardless of the operation amounts of the accelerator pedal 37 and the brake pedal 41. When the driving assistance ECU 21 determines that the vehicle speed condition is not satisfied (that is, the vehicle 10 is traveling at a speed higher than the vehicle speed threshold value), but the second obstacle condition and the second erroneous operation condition are satisfied, the driving assistance ECU 21 transmits, to the brake ECU 23, a deceleration command including a target deceleration of the vehicle 10, and transmits, to the engine ECU 22, the driving force control command including the target driving force of the engine 38. When the brake ECU 23 receives the deceleration command from the driving assistance ECU 21, the brake ECU 23 controls the brake actuator 40 so that the vehicle 10 decelerates at the target deceleration included in the deceleration command. Moreover, when the engine ECU 22 receives the driving force control command from the driving assistance ECU 21, the engine ECU 22 controls the engine actuator 36 so that the driving force of the engine 38 reaches the target driving force regardless of the operation amount of the accelerator pedal 37. The target driving force in the deceleration control is registered in advance in the driving assistance ECU 21.

The target deceleration in the deceleration control is set to such a deceleration that the vehicle 10 can be stopped before the vehicle 10 collides with a marked obstacle (at a position before the marked obstacle). The driving assistance ECU 21 calculates this target deceleration based on the vehicle speed and a distance from the vehicle 10 to the marked obstacle. Moreover, the target driving force in the deceleration control is a driving force at the time of, for example, the idling (in the case in which the operation amount of the accelerator pedal 37 is 0%).

(Deceleration Finish Condition)

A deceleration finish condition is a condition for finishing the deceleration control, and is a condition indicating that a possibility of the collision of the vehicle 10 with a marked obstacle has disappeared or has decreased. The driving assistance ECU 21 determines that the deceleration finish condition is satisfied when at least one of the following condition C1 or condition C2 is satisfied.

Condition C1: The predicted time to collision is longer than a second time threshold value.

Condition C2: The vehicle 10 has stopped (the vehicle speed has become 0 km/h)

The driving assistance ECU 21 determines whether or not the predicted time to collision has exceeded the second time threshold value. This second time threshold value is a value larger than the first time threshold value, and a value set in advance is registered in advance in the driving assistance ECU 21.

When the driving assistance ECU 21 determines that the deceleration finish condition is satisfied, the driving assistance ECU 21 finishes the deceleration control. When the deceleration finish condition is satisfied as a result of the satisfaction of the condition C2, the driving assistance ECU 21 transmits a stop holding command to the brake ECU 23 until a predetermined period of time (for example, two seconds) has elapsed since a time point at which the deceleration finish condition was satisfied. While the brake ECU 23 is receiving the stop holding command from the driving assistance ECU 21, the brake ECU 23 controls the brake actuator 40 to continue the state in which the friction brake mechanisms are applying to the wheels such braking forces that the stop state of the vehicle 10 can be maintained. Thus, when the vehicle 10 stops, the stop of the vehicle 10 is maintained for the predetermined period of time after the stop.

(Avoidance Operation Condition)

The avoidance operation condition is a condition indicating that the driver has executed the steering operation for avoiding a collision of the vehicle 10 with an obstacle. For example, when the driver recognizes a marked obstacle, the driver may cause the vehicle 10 to travel at a vehicle speed intended by the driver along a path intended by the driver, to thereby try to avoid a collision of the vehicle 10 with the marked obstacle. When the deceleration control is executed in this case, there is a fear in that the driver may not be capable of causing the vehicle 10 to travel at the vehicle speed intended by the driver along the path intended by the driver. Thus, the driving assistance ECU 21 determines whether or not the avoidance operation condition is satisfied. In a case in which the avoidance operation condition is satisfied during the execution of the vehicle speed suppression control (this case includes a case in which the avoidance operation condition is satisfied before the start of the execution of the vehicle speed suppression control, and the satisfaction state continues after the start of the vehicle speed suppression control; this applies hereinafter), the driving assistance ECU 21 stops the vehicle speed suppression control. The driving assistance ECU 21 always starts the deceleration control when the vehicle speed condition is not satisfied and the second obstacle condition and the second erroneous operation condition are satisfied. After that, the driving assistance ECU 21 stops the deceleration control when the avoidance operation condition is satisfied during the execution of the deceleration control, and continues the deceleration control when the avoidance operation condition is not satisfied. Then, when the deceleration finish condition is satisfied, the driving assistance ECU 21 finishes the deceleration control.

When the driving assistance ECU 21 determines that at least one of a condition D1 or a condition D2 described below is satisfied, the driving assistance ECU 21 determines that the avoidance operation condition is satisfied.

Condition D1: The operation amount (=steering angle) of the steering wheel 48 is larger than an avoidance operation amount threshold value.

Condition D2: The operation speed of the steering wheel 48 is higher than an avoidance operation speed threshold value.

It is assumed that the operation amount of the steering wheel 48 to be used in the determination of the avoidance operation condition presents a larger value as a position is further apart leftward or rightward from a neutral position (position for a straight travel of the vehicle 10) regardless of whether the position is apart in the right direction or the left direction. Moreover, it is assumed that the operation speed of the steering wheel 48 indicates an absolute value of a change amount per unit time of the operation amount of the steering wheel 48. The avoidance operation amount threshold value and the avoidance operation speed threshold value are set in advance based on an operation amount of the steering wheel 48 and an operation speed of the steering wheel 48 at which the steering operation by the driver are considered to be prioritized over the deceleration control. As the operation amount of the steering wheel 48, the steering angle of the steering wheel 48 can be exemplified. As the operation speed of the steering wheel 48, the steering angular velocity of the steering wheel 48 can be exemplified. Those values can be acquired based on the steering angle detected by the steering operation sensor 46.

Moreover, the driving assistance ECU 21 does not stop the driving force suppression control and continues the driving force suppression control even when the avoidance operation condition is satisfied in the case in which the driving force suppression control is started through the satisfaction of the vehicle speed condition, the first obstacle condition, and the first erroneous operation condition. In this manner, the driving assistance ECU 21 inhibits the deceleration control when the avoidance operation condition is satisfied in the case in which the vehicle speed condition is not satisfied, but does not inhibit the driving force suppression control even when the avoidance operation condition is satisfied (or without determining whether or not the avoidance operation condition is satisfied) in the case in which the vehicle speed condition is satisfied.

With this configuration, it is possible to appropriately avoid a collision with a marked obstacle. That is, during a travel of the vehicle 10 at a vehicle speed higher than the vehicle speed threshold value, when the existence of a marked obstacle is detected (when the obstacle condition is satisfied), and when the driver erroneously operates the acceleration pedal (when the erroneous operation condition is satisfied), the driving assistance ECU 21 executes the vehicle speed suppression control (deceleration control), to thereby decelerate the vehicle 10. As a result, the driver is assisted in the avoidance of a collision of the vehicle 10 with the marked obstacle. Moreover, when the driver recognizes an existence of a marked obstacle during a travel of the vehicle 10 at a vehicle speed higher than the vehicle speed threshold value, the driver may execute the avoidance operation so that the vehicle 10 does not collide with this marked obstacle. In some embodiments, the vehicle 10 may travel at a speed intended by the driver along a path intended by the driver. In some embodiments, when the driver intends to avoid a collision with the marked obstacle through the driving operation of the driver, the driving operation of the driver may be prioritized. Thus, in the first embodiment, the vehicle speed suppression control is inhibited when the driver executes the avoidance operation (when the avoidance operation condition is satisfied) in the case in which the vehicle speed is equal to or higher than the vehicle speed threshold value. As a result, the driver can avoid a collision with a marked obstacle through the driving operation of the driver without interference of the vehicle speed suppression control (deceleration control).

Meanwhile, when the vehicle speed suppression control is inhibited at the time when the vehicle 10 starts or travels at low speed (for example, travels slowly), there is a fear in that the vehicle 10 may suddenly start or suddenly accelerate from the low speed. In this respect, in the case in which the vehicle speed condition is satisfied, the driving assistance ECU 21 does not inhibit the driving force suppression control even when the avoidance operation condition is satisfied. With this control, it is possible to prevent or suppress a sudden start or a sudden acceleration from low speed of the vehicle 10 under the state in which a marked obstacle exists. As a result, it is possible to appropriately avoid a collision with the marked obstacle due to the sudden start or the sudden acceleration.

The case in which the vehicle speed condition and the first erroneous operation condition are satisfied is a case in which the operation amount of the accelerator pedal 37 rapidly increases from 0 or a value close to 0. In this case, it is likely that an abnormality currently occurs in the driver. When an abnormality currently occurs in the driver, the driver may execute a steering operation even when the driver does not intend to execute the steering operation. Thus, when the driving force suppression control is inhibited in this case, there is a fear in that the vehicle 10 may suddenly start or suddenly accelerate from low speed despite the abnormality occurring in the driver. In this respect, according to the first embodiment, when an abnormality has occurred in the driver, it is possible to prevent or suppress the sudden start and the sudden acceleration from low speed of the vehicle 10, thereby being capable of appropriately avoiding a collision with a marked obstacle.

<Specific Operation of Driving Assistance ECU>

Description is now given of an example of a specific operation of the driving assistance ECU 21. The CPU of the driving assistance ECU 21 repeatedly executes, at a predetermined short cycle, a vehicle speed condition determination routine, an obstacle condition determination routine, an avoidance operation condition determination routine, an erroneous operation condition determination routine, and a collision avoidance assistance routine in parallel while an ignition switch (main switch) (not shown) of the vehicle 10 is ON. Those routines (computer programs) are stored in advance in the ROM of the driving assistance ECU 21. Moreover, the CPU of the driving assistance ECU 21 reads out those routines from the ROM, and loads those routines onto the RAM to execute the routines. In description given below, the CPU of the driving assistance ECU 21 is simply referred to as “CPU.”

(Vehicle Speed Condition Determination Routine)

The vehicle speed condition determination routine is a routine for determining whether or not the vehicle speed condition is satisfied. The CPU acquires the vehicle speed detected by the vehicle speed sensor 32. When the acquired vehicle speed is equal to or lower than the vehicle speed threshold value, the CPU determines that the vehicle speed condition is satisfied. When the acquired vehicle speed is higher than the vehicle speed threshold value, the CPU determines that the vehicle speed condition is not satisfied. When the CPU determines that the vehicle speed condition is satisfied, the CPU sets a “vehicle speed condition determination value” to “1 (satisfied).” When the CPU determines that the vehicle speed condition is not satisfied, the CPU sets the “vehicle speed condition determination value” to “0 (not satisfied).” After that, the CPU temporarily stores the vehicle speed condition determination value in the RAM. Thus, the vehicle speed condition determination value is “1” while the vehicle speed condition is satisfied, and is “0” while the vehicle speed condition is not satisfied.

(Obstacle Condition Determination Routine)

The obstacle condition determination routine is a routine for determining whether or not a marked obstacle exists. The CPU searches for an obstacle existing in the range of the predicted travel trajectory in the travel direction of the vehicle 10 based on the detection result of the position of the shift lever 44 acquired from the shift lever position sensor 42 and the object information acquired from the peripheral sensor 31. After that, when such an object is detected, the CPU determines whether or not the distance from the vehicle 10 to the detected obstacle is equal to or shorter than the predetermined threshold value based on the object information acquired from the peripheral sensor 31. Then, when the distance from the vehicle 10 to the obstacle is equal to or shorter than the threshold value, the CPU determines that the first obstacle condition is satisfied. When this distance is longer than the threshold value, the CPU determines that the first obstacle condition is not satisfied. When the CPU determines that the first obstacle condition is satisfied, the CPU sets a “first obstacle condition determination value” to “1.” When the CPU determines that the first obstacle condition is not satisfied, the CPU sets the “first obstacle condition determination value” to “0.” After that, the CPU temporarily stores the first obstacle condition determination value in the RAM. Thus, the first obstacle condition determination value is “1” while the first obstacle condition is satisfied, and is “0” while the first obstacle condition is not satisfied.

Further, when an obstacle existing in the range of the predicted travel trajectory in the travel direction of the vehicle 10 is detected, the CPU calculates the predicted time to collision based on the detection result of the vehicle speed acquired from the vehicle speed sensor 32, and determines whether or not the calculated predicted time to collision is equal to or shorter than the first time threshold value. When the predicted time to collision is equal to or shorter than the first time threshold value, the CPU determines that the second obstacle condition is satisfied. When the predicted time to collision is longer than the first time threshold value, the CPU determines that the obstacle condition is not satisfied. Then, when the CPU determines that the second obstacle condition is satisfied, the CPU sets a “second obstacle condition determination value” to “1.” When the CPU determines that the second obstacle condition is not satisfied, the CPU sets the “second obstacle condition determination value” to “0.” After that, the CPU temporarily stores the second obstacle condition determination value in the RAM. Thus, the second obstacle condition determination value is “1” while the second obstacle condition is satisfied, and is “0” while the second obstacle condition is not satisfied.

(Erroneous Operation Condition Determination Routine)

The erroneous operation condition determination routine is a routine for determining whether or not the erroneous operation condition is satisfied. The CPU determines whether or not the above-mentioned condition A1 is satisfied based on the operation amount of the accelerator pedal 37 and the operation speed of the accelerator pedal 37 calculated from the operation amount of the accelerator pedal 37. After that, when the CPU determines that the condition A1 is satisfied, the CPU determines that the first erroneous operation condition is satisfied. When the condition A1 is not satisfied, the CPU determines that the first erroneous operation condition is not satisfied. As described above, when the CPU determines both of the condition A1 and the condition A2 are satisfied, the CPU may determine that the first erroneous operation condition is satisfied. When the CPU determines that at least one of the condition A1 or the condition A2 is not satisfied, the CPU may determine that the first erroneous operation condition is not satisfied. When the CPU determines that the first erroneous operation condition is satisfied, the CPU sets a “first erroneous operation condition determination value” to “1.” When the CPU determines that the first erroneous operation condition is not satisfied, the CPU sets the “first erroneous operation condition determination value” to “0.” After that, the CPU temporarily stores the first erroneous operation condition determination value in the RAM. Thus, the first erroneous operation condition determination value is “1” while the first erroneous operation condition is satisfied, and is “0” while the first erroneous operation condition is not satisfied.

Moreover, the CPU determines whether or not the above-mentioned condition B1 and condition B2 are satisfied based on the operation amount of the accelerator pedal 37, the operation speed of the accelerator pedal 37 calculated from the operation amount of the accelerator pedal 37, the operation amount of the brake pedal 41, and the detection result of the position of the turn signal lever 34 obtained by the turn signal lever position sensor 33. When the driving assistance ECU 21 determines that both of the condition B1 and the condition B2 are satisfied, the driving assistance ECU 21 determines that the second erroneous operation condition is satisfied. When the driving assistance ECU 21 determines that one or both of the condition B1 and the condition B2 are not satisfied, the driving assistance ECU 21 determines that the second erroneous operation condition is not satisfied. When the CPU determines that the second erroneous operation condition is satisfied, the CPU sets a “second erroneous operation condition determination value” to “1.” When the CPU determines that the second erroneous operation condition is not satisfied, the CPU sets the “second erroneous operation condition determination value” to “0.” After that, the CPU temporarily stores the second erroneous operation condition determination value in the RAM. Thus, the second erroneous operation condition determination value is “1” while the second erroneous operation condition is satisfied, and is “0” while the second erroneous operation condition is not satisfied.

(Avoidance Operation Condition Determination Routine)

The avoidance operation condition determination routine is a routine for determining whether or not the avoidance operation condition is satisfied. The CPU acquires the operation amount (for example, the steering angle) of the steering wheel 48 detected by the steering operation sensor 46, and differentiates, with respect to time, the acquired operation amount of the steering wheel 48, to thereby calculate the operation speed (for example, the steering angular velocity) of the steering wheel 48. After that, the CPU determines whether or not the above-mentioned condition D1 and condition D2 are satisfied based on the operation amount and the operation speed of the steering wheel 48. When the CPU determines that at least one of the condition D1 or the condition D2 is satisfied, the CPU determines that the avoidance operation condition is satisfied. Meanwhile, when none of the condition D1 and the condition D2 is satisfied, the CPU determines that the avoidance operation condition is not satisfied. When the CPU determines that the avoidance operation condition is satisfied, the CPU sets an “avoidance operation condition determination value” to “1.” When the CPU determines that the avoidance operation condition is not satisfied, the CPU sets the “avoidance operation condition determination value” to “0.” After that, the CPU temporarily stores the avoidance operation condition determination value in the RAM. Thus, the avoidance operation condition determination value is “1” while the avoidance operation condition is satisfied, and is “0” while the avoidance operation condition is not satisfied.

(Collision Avoidance Assistance Routine)

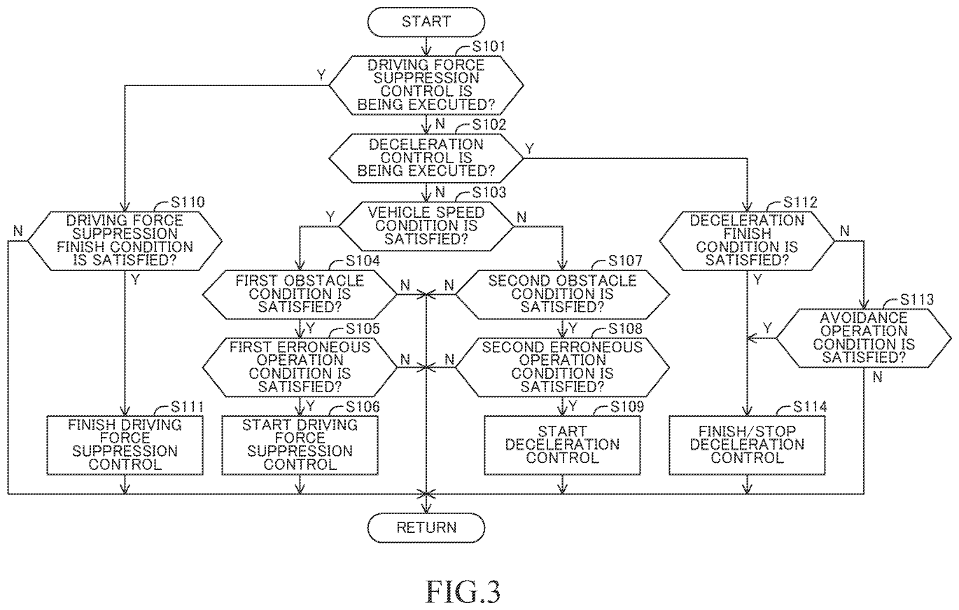

The collision avoidance assistance routine is a main routine for executing the collision avoidance assistance control. FIG. 3 is a flowchart for illustrating the collision avoidance assistance routine.

When the collision avoidance assistance routine starts, the CPU determines whether or not the driving force suppression control is being executed in Step S101. Specifically, the CPU determines whether a driving force suppression control determination value described below is “0” or “1.” When the driving force suppression control is not being executed (when the driving force suppression control determination value is “0”), the CPU advances the process to Step S102. When the driving force suppression control is being executed (when the driving force suppression control determination value is “1”), the CPU advances the process to Step S110.

In Step S102, the CPU determines whether or not the deceleration control is being executed. Specifically, the CPU determines whether a deceleration control determination value described below is “0” or “1.” Then, when the deceleration control is not being executed (when the deceleration control determination value is “0”), the CPU advances the process to Step S103. When the deceleration control is being executed (when the deceleration control determination value is “1”), the CPU advances the process to Step S112.

In Step S103, the CPU determines whether or not the vehicle speed condition is satisfied. Specifically, the CPU determines whether the vehicle speed condition determination value is “0” or “1.” Then, when the vehicle speed condition is satisfied (when the vehicle speed condition determination value is “1”), the CPU advances the process to Step S104. When the vehicle speed condition is not satisfied (when the vehicle speed condition determination value is “0”), the CPU advances the process to Step S107.

In Step S104, the CPU determines whether or not the first obstacle condition is satisfied. Specifically, the CPU determines whether the first obstacle condition determination value is “0” or “1.” When the CPU determines that the first obstacle condition is satisfied (when the first obstacle condition determination value is “1”), the CPU advances the process to Step S105. When the CPU determines that the first obstacle condition is not satisfied (when the first obstacle condition determination value is “0”), the CPU temporarily finishes this collision avoidance assistance routine.

In Step S105, the CPU determines whether or not the first erroneous operation condition is satisfied. Specifically, the CPU determines whether the first erroneous operation condition determination value is “1” or “0.” Then, when the CPU determines that the first erroneous operation condition is satisfied (when the first erroneous operation condition determination value is “1”), the CPU advances the process to Step S106. Meanwhile, when the CPU determines that the first erroneous operation condition is not satisfied (when the first erroneous operation condition determination value is “0”), the CPU temporarily finishes this collision avoidance assistance routine.

In Step S106, the CPU starts the driving force suppression control. Moreover, the CPU sets the driving force suppression control determination value to “1.” After that, the CPU temporarily finishes this collision avoidance assistance routine. An initial value (a value at the time point when the ignition switch is turned on) of the driving force suppression control determination value is “0.”

When the CPU determines that the vehicle speed condition is not satisfied in Step S103, the CPU advances the process to Step S107. In Step S107, the CPU determines whether or not the second obstacle condition is satisfied. Specifically, the CPU determines whether the second obstacle condition determination value is “0” or “1.” When the CPU determines that the second obstacle condition is satisfied (when the second obstacle condition determination value is “1”), the CPU advances the process to Step S108. When the CPU determines that the second obstacle condition is not satisfied (when the second obstacle condition determination value is “0”), the CPU temporarily finishes this collision avoidance assistance routine.

In Step S108, the CPU determines whether or not the second erroneous operation condition is satisfied. Specifically, the CPU determines whether the second erroneous operation condition determination value is “1” or “0.” Then, when the CPU determines that the second erroneous operation condition is satisfied (when the second erroneous operation condition determination value is “1”), the CPU advances the process to Step S109. Meanwhile, when the CPU determines that the second erroneous operation condition is not satisfied (when the second erroneous operation condition determination value is “0”), the CPU temporarily finishes this collision avoidance assistance routine.

In Step S109, the CPU starts the deceleration control. Moreover, the CPU sets the deceleration control determination value to “1.” After that, the CPU temporarily finishes this collision avoidance assistance routine. An initial value (a value at the time point when the ignition switch is turned on) of the deceleration control determination value is “0.”

When the CPU determines that the driving force suppression control is being executed in Step S101, the CPU advances the process to Step S110. In Step S110, the CPU determines whether or not the driving force suppression finish condition is satisfied. Specifically, when the operation amount of the accelerator pedal 37 is equal to or smaller than the fourth operation amount threshold value, the CPU determines that the driving force suppression finish condition is satisfied. When the CPU determines that the driving force suppression finish condition is satisfied, the CPU advances the process to Step S111. Meanwhile, when the CPU determines that the driving force suppression finish condition is not satisfied, the CPU temporarily finishes this collision avoidance assistance routine. Thus, in this case, the driving force suppression control is continued.

In Step S111, the CPU finishes the driving force suppression control. Moreover, the CPU sets the driving force suppression control determination value to “0.” After that, the CPU temporarily finishes this collision avoidance assistance routine.

When the CPU determines that the deceleration control is being executed in Step S102, the CPU advances the process to Step S112. In Step S112, the CPU determines whether or not the deceleration finish condition is satisfied. Specifically, the CPU determines whether or not the predicted time to collision is equal to or longer than the second time threshold value, and whether or not the vehicle speed is 0 km/h. When any one of “the predicted time to collision is equal to or longer than the second time threshold value” and “the vehicle speed is 0 km/h” is satisfied, the CPU determines that the deceleration finish condition is satisfied. When the CPU determines that the deceleration finish condition is not satisfied, the CPU advances the process to Step S113. When the CPU determines that the deceleration finish condition is satisfied, the CPU advances the process to Step S114.

In Step S113, the CPU determines whether or not the avoidance operation condition is satisfied. Specifically, the CPU determines whether the avoidance operation condition determination value is “0” or “1.” Then, when the CPU determines that the avoidance operation condition is not satisfied (when the avoidance operation condition determination value is “0”), the CPU temporarily finishes this collision avoidance assistance routine. Thus, in this case, the deceleration control is continued. Meanwhile, when the CPU determines that the avoidance operation condition is satisfied (when the avoidance operation condition determination value is “1”), the CPU advances the process to Step S114.

In Step S114, the CPU finishes the deceleration control. Moreover, the CPU sets the deceleration control determination value to “0.” After that, the CPU temporarily finishes this collision avoidance assistance routine.

According to the collision avoidance assistance routine described above, the above-mentioned collision avoidance assistance control is achieved. That is, when all of the vehicle speed condition, the first obstacle condition, and the first erroneous operation condition are satisfied (“Y” in Step S103, in Step S104, and in Step S105), the driving force suppression control is started (Step S106). Meanwhile, when the vehicle speed condition is not satisfied, but the second obstacle condition and the second erroneous operation condition are satisfied (“N” in Step S103, and “Y” in Step S107 and in Step S108), the deceleration control is started (Step S109).

Moreover, when the driving force suppression finish condition is satisfied (“Y” in Step S110) during the execution of the driving force suppression control (“Y” in Step S101), the driving force suppression control is finished. Meanwhile, when the deceleration finish condition is satisfied (“Y” in Step S112) during the execution of the deceleration control (“Y” in Step S102), the deceleration control is finished. Moreover, when the avoidance operation condition is satisfied (“Y” in Step S113) while the deceleration control is being executed (“Y” in Step S102) and the deceleration finish condition is not satisfied (“N” in Step S112), the deceleration control is stopped. However, while the driving force suppression control is being executed (“Y” in Step S101) and the driving force suppression finish condition is not satisfied (“N” in Step S110), the driving force suppression control is continued even when the avoidance operation condition is satisfied (processing step corresponding to Step S111 is not to be executed).

### Second Embodiment

Description is now given of a second embodiment of the present disclosure. When the avoidance operation condition is satisfied, the driving assistance ECU 21 of the assistance device 11 according to the second embodiment inhibits the vehicle speed suppression control (the driving force suppression control and the deceleration control) regardless of whether or not the vehicle speed condition is satisfied. The same reference symbols are assigned to components common to those in the first embodiment, and description thereof is omitted. Moreover, the configuration of the assistance device 11 of the second embodiment may be the same as the configuration of the assistance device 11 of the first embodiment.

(Avoidance Operation Condition)

The driving assistance ECU 21 determines that the avoidance operation condition is satisfied when at least one of the condition D1 or the condition D2 is satisfied and the following condition D3 is satisfied.

Condition D3: A steering operation at the time when it is determined whether or not each of the condition D1 and the condition D2 is satisfied is an operation toward a direction in which the obstacle does not exist.

With reference to FIG. 2, description is now given of the condition D3. As illustrated in FIG. 2, the following case is assumed: a part of the obstacle O₁ exists in the predicted travel trajectory of the vehicle 10, the rest of the object O₁ and the another obstacle O₂ (for example, a guard rail) exist outside the range of the predicted travel trajectory in one of the left side and the right side (in FIG. 2, left side) of the predicted travel trajectory of the vehicle 10, and other obstacles do not exist on the opposite side thereof (in FIG. 2, right side). Moreover, it is assumed that the position of the shift lever 44 (shift range of the transmission 45) is the position for moving forward the vehicle 10. In this case, the driver can avoid a collision of the vehicle 10 with the obstacle O₁ and the obstacle O₂ by executing the steering operation so that the vehicle 10 travels on the opposite side of the side on which the obstacle O₂ exists (side on which the obstacle do not exist; in FIG. 2, the right side). Accordingly, this steering operation can be considered as an operation for avoiding a collision of the vehicle 10 with the obstacle O₁ and the obstacle O₂. Thus, when this steering operation (steering operation for avoiding the obstacles) is detected, the driving assistance ECU 21 inhibits the vehicle speed suppression control so that the driver can avoid the collision of the vehicle 10 with the obstacle O₁ and the obstacle O₂ by the operation of the accelerator pedal 37 and the steering operation of the driver.

The driving assistance ECU 21 determines whether or not obstacles exist in a “range in which a collision of the vehicle 10 is highly likely to occur when the vehicle 10 turns through the steering operation,” and determines whether or not obstacles do not exist on the opposite side thereof. This range is specifically as follows.

When the position (shift range) of the shift lever 44 is at a position for moving forward the vehicle 10 (forward travel range):

Range (1): A range on the right side and a front right side of the vehicle 10, and a range within a predetermined distance from the vehicle 10

Range (2): A range on the left side and a front left side of the vehicle 10, and a range within a predetermined distance from the vehicle 10

When the position (shift range) of the shift lever 44 is at a position for moving backward the vehicle 10 (backward travel range):

Range (3): A range on the right side and a rear right side of the vehicle 10, and a range within a predetermined distance from the vehicle 10

Range (4): A range on the left side and a rear left side of the vehicle 10, and a range within a predetermined distance from the vehicle 10

In FIG. 2, the range (1) is a “range on the right side of the straight line A₁ and within the predetermined distance from the straight line A₁, and on a front side of the line A₄ and within the predetermined distance from the line A₃ and forward of the vehicle 10.” The range (2) is a “range on the left side of the straight line A₂ and within the predetermined distance from the straight line A₂, and on a front side of the line A₄ and within the predetermined distance from the line A₃ and forward of the vehicle 10.” The range (3) is a “range on the right side of the straight line A₁ and within the predetermined distance from the straight line A₁, and on a rear side of the line A₃ and within the predetermined distance from the line A₄ and forward of the vehicle 10.” The range (4) is a “range on the left side of the straight line A₂ and within the predetermined distance from the straight line A₂, and on a rear side of the line A₄ and within the predetermined distance from the line A₄ and backward of the vehicle 10.”

The driving assistance ECU 21 determines, based on the object information acquired from the peripheral sensor 31, whether or not obstacles exist outside the range of the predicted travel trajectory of the vehicle 10, and exist in the “range in which a collision of the vehicle 10 is highly likely to occur when the vehicle 10 turns through the steering operation,” and determines whether or not obstacles do not exist on the opposite side thereof. For example, when obstacles are not continuously detected for a predetermined period of time or longer in this range, the driving assistance ECU 21 determines that obstacles do not exist in this range. Further, when the shift position is the position for moving forward the vehicle 10, the driving assistance ECU 21 determines that obstacles exist in any one of the range (1) and the range (2), and determines that the above-mentioned condition D3 is satisfied when the steering operation is the operation for causing the vehicle 10 to travel toward the side on which the obstacles do not exist. Meanwhile, when the shift position is the position for moving backward the vehicle 10, the driving assistance ECU 21 determines that obstacles exist in any one of the range (3) and the range (4), and determines that the above-mentioned condition D3 is satisfied when the steering operation is the operation for causing the vehicle 10 to travel toward the side on which the obstacles do not exist.

After that, when the driving assistance ECU 21 determines that the avoidance operation condition is satisfied during the execution of the deceleration control, the driving assistance ECU 21 stops the deceleration control. Similarly, when the driving assistance ECU 21 determines that the avoidance operation condition is satisfied during the execution of the driving force suppression control, the driving assistance ECU 21 finishes the driving force suppression control. When the avoidance operation condition is no longer satisfied after the driving force suppression control is stopped, the driving assistance ECU 21 determines that the driving force suppression finish condition is satisfied when a predetermined period of time has elapsed since the dissatisfaction of the avoidance operation condition. With this control, it is possible to highly accurately determine whether or not the steering operation is the operation for avoiding a collision with an obstacle (that is, whether or not the steering operation is intended by the driver). Then, when the driving assistance ECU 21 determines that the avoidance operation condition is not satisfied, the driving assistance ECU 21 permits the vehicle speed suppression control, to thereby avoid the obstacle through the vehicle speed suppression control. Meanwhile, when the steering operation is the operation for avoiding the collision with the obstacle, the driving assistance ECU 21 inhibits the deceleration control and the driving force suppression control, to thereby avoid the collision through the driving operation of the driver of the vehicle 10.

The avoidance operation condition may be changed between the case in which the vehicle speed condition is satisfied and the case in which the vehicle speed condition is not satisfied. For example, when the vehicle speed condition is satisfied, the driving force suppression control may be inhibited depending on whether or not the above-mentioned avoidance operation condition (avoidance operation condition in the second embodiment) is satisfied. When the vehicle speed condition is not satisfied, the deceleration control may be inhibited depending on whether or not the avoidance operation condition in the first embodiment is satisfied.

<Specific Operation of Driving Assistance ECU>

Description is now given of an example of a specific operation of the driving assistance ECU 21. As in the first embodiment, the CPU repeatedly executes, at a predetermined short cycle, a vehicle speed condition determination routine, an obstacle condition determination routine, an avoidance operation condition determination routine, an erroneous operation condition determination routine, and a collision avoidance assistance routine in parallel while the ignition switch (main switch) of the vehicle 10 is ON. The vehicle speed condition determination routine, the obstacle condition determination routine, and the erroneous operation condition determination routine are the same as those in the first embodiment, and description thereof is therefore omitted.

(Avoidance Operation Condition Determination Routine)

The avoidance operation condition determination routine is a routine for determining whether or not the avoidance operation condition is satisfied. The CPU acquires the operation amount of the steering wheel 48 detected by the steering operation sensor 46, and differentiates, with respect to time, the acquired operation amount of the steering wheel 48, to thereby calculate the operation speed of the steering wheel 48. After that, the CPU determines whether or not the above-mentioned condition D1 and condition D2 are satisfied based on the operation amount and the operation speed of the steering wheel 48. When the CPU determines that at least one of the condition D1 or the condition D2 is satisfied, and the above-mentioned condition D3 is satisfied, the CPU determines that the avoidance operation condition is satisfied. Meanwhile, when none of the condition D1 and the condition D2 is satisfied, or when at least one of the condition D1 or the condition D2 is satisfied, but the condition D3 is not satisfied, the CPU determines that the avoidance operation condition is not satisfied. When the CPU determines that the avoidance operation condition is satisfied, the CPU sets the “avoidance operation condition determination value” to “1.” When the CPU determines that the avoidance operation condition is not satisfied, the CPU sets the “avoidance operation condition determination value” to “0.” After that, the CPU temporarily stores the avoidance operation condition determination value in the RAM. Thus, the avoidance operation condition determination value is “1” while the avoidance operation condition is satisfied, and is “0” while the avoidance operation condition is not satisfied.

(Collision Avoidance Assistance Routine)

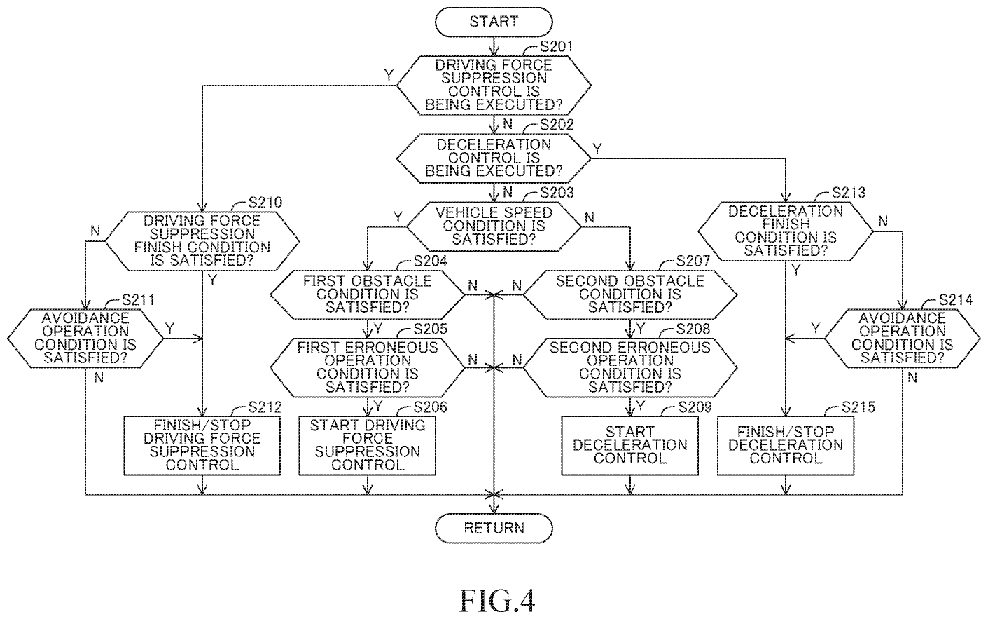

FIG. 4 is a flowchart for illustrating a collision avoidance assistance routine in the second embodiment executed by the CPU. The CPU repeatedly executes this collision avoidance assistance routine at a predetermined cycle. Step S201 to Step S209 and Step S212 to Step S215 are substantially the same as Step S101 to Step S109 and Step S111 to Step S114 in the first embodiment, respectively. Thus, description thereof is omitted.

In Step S210, the CPU determines whether or not the driving force suppression finish condition is satisfied. Specifically, the CPU determines whether or not the avoidance operation condition is no longer satisfied. When the avoidance operation condition is no longer satisfied, the CPU determines whether or not the predetermined period of time has elapsed since the dissatisfaction of the avoidance operation condition. Then, when the predetermined period of time has elapsed since the dissatisfaction of the avoidance operation condition, the CPU determines that the driving force suppression finish condition is satisfied.

When the CPU determines that the driving force suppression finish condition is not satisfied in Step S210, the CPU advances the process to Step S211. In Step S211, the CPU determines whether or not the avoidance operation condition is satisfied. When the CPU determines that the avoidance operation condition is not satisfied, the CPU temporarily finishes this collision avoidance assistance routine. Meanwhile, when the CPU determines that the avoidance operation condition is satisfied, the CPU advances the process to Step S212. In Step S212, the CPU stops the driving force suppression control. After that, the CPU temporarily finishes this collision avoidance assistance routine.

According to the collision avoidance assistance routine described above, the above-mentioned collision avoidance assistance control is achieved. That is, when the deceleration finish condition is not satisfied (“N” in Step S213), but the avoidance operation condition is satisfied (“Y” in Step S214) while the deceleration control is being executed (“Y” in Step S202), the deceleration control is stopped. Similarly, when the driving force suppression finish condition is not satisfied (“N” in Step S210), but the avoidance operation condition is satisfied (“Y” in Step S211) while the driving force suppression control is being executed (“Y” in Step S201), the driving force suppression control is stopped.

In the above, the collision avoidance assistance device according to each of the embodiments has been described, but the present disclosure is not limited to each of the above-mentioned embodiments, and various changes are possible within the range not departing from the object of the present disclosure.

For example, in the above-mentioned embodiments, there has been described the example in which the peripheral sensor 31 is the peripheral information acquisition device, but the present disclosure is not limited to such a configuration. For example, the peripheral sensor 31 and the driving assistance ECU 21 may cooperate with each other to function as the peripheral information acquisition device. Moreover, the collision avoidance assistance device 11 of the vehicle 10 may include an ECU other than the ECUs described in the embodiments, and the peripheral sensor 31 and this ECU may cooperate with each other to function as the peripheral information acquisition device.

Moreover, in the above-mentioned embodiments, there has been described the configuration in which the vehicle speed suppression control is always executed when the obstacle condition and the erroneous operation condition are satisfied, but the present disclosure is not limited to this configuration. For example, in a case in which the avoidance operation condition is satisfied at the time point when the obstacle condition and the erroneous operation condition are satisfied, the vehicle speed suppression control is not required to be executed.

Moreover, the contents of the vehicle speed condition, the obstacle condition, the erroneous operation condition, and the avoidance operation condition are not limited to the contents described in the above-mentioned embodiments. The contents of those conditions can appropriately be set.

What is claimed is:

1. A collision avoidance assistance device for a vehicle, comprising:
a peripheral information acquisition device configured to acquire object information being information on an object existing in a peripheral region of the vehicle; and
a control device configured to:
determine whether an obstacle condition indicating that an obstacle with which the vehicle is highly likely to collide exists is satisfied based on the object information acquired by the peripheral information acquisition device;
determine whether an erroneous operation condition indicating that a driving force increase operation executed by a driver for increasing a driving force output by a driving force source of the vehicle is an erroneous operation is satisfied and whether an avoidance operation condition indicating that a steering operation for avoiding a collision of the vehicle with the obstacle has been executed is satisfied;
execute vehicle speed suppression control of reducing a speed of the vehicle so that the speed is lower than a speed set by the driving force increase operation when the obstacle condition and the erroneous operation condition are determined to be satisfied;
inhibit the vehicle speed suppression control in a case in which the avoidance operation condition is satisfied when the speed of the vehicle is higher than a vehicle speed threshold value; and
allow the vehicle speed suppression control in a case in which the avoidance operation condition is satisfied when the speed of the vehicle is equal to or lower than the vehicle speed threshold value.

2. A collision avoidance assistance device for a vehicle, comprising:
a peripheral information acquisition device configured to acquire object information being information on an object existing in a peripheral region of the vehicle; and
a control device configured to:
determine whether an obstacle condition indicating that an obstacle with which the vehicle is highly likely to collide exists is satisfied based on the object information acquired by the peripheral information acquisition device;
determine whether an erroneous operation condition indicating that a driving force increase operation executed by a driver for increasing a driving force output by a driving force source of the vehicle is an erroneous operation is satisfied and whether an avoidance operation condition indicating that a steering operation for avoiding a collision of the vehicle with the obstacle has been executed is satisfied;
execute vehicle speed suppression control of reducing a speed of the vehicle so that the speed is lower than a speed set by the driving force increase operation when the obstacle condition and the erroneous operation condition are determined to be satisfied; and
inhibit the vehicle speed suppression control when the avoidance operation condition is determined to be satisfied,
wherein the control device is configured to determine that the avoidance operation condition is satisfied when the obstacle condition and the erroneous operation condition are satisfied, another obstacle different from the obstacle exists on one side out of a right outer side and a left outer side of a predicted travel trajectory of the vehicle, and the steering operation is an operation for moving the vehicle to a direction opposite to the one side.

3. The collision avoidance assistance device for a vehicle according to claim 1,
wherein the driving force increase operation is an operation for increasing an operation amount of an accelerator pedal, and
wherein the control device is configured to determine that the erroneous operation condition is satisfied in a case in which the operation amount of the accelerator pedal is equal to or larger than a threshold value when the speed of the vehicle is equal to or lower than the vehicle speed threshold value.

4. The collision avoidance assistance device for a vehicle according to claim 1, wherein the vehicle speed suppression control is control of setting a driving force output by an internal combustion engine being the driving force source of the vehicle to a driving force at idling when the speed of the vehicle is equal to or lower than the vehicle speed threshold value.

5. The collision avoidance assistance control device for a vehicle according to claim 1, wherein the vehicle speed suppression control is control of setting the driving force output by the driving force source of the vehicle to a driving force which allows a state in which the vehicle is stopped on an inclined road surface to be maintained when the speed of the vehicle is equal to or lower than the vehicle speed threshold value.

6. The collision avoidance assistance control device for a vehicle according to claim 1, wherein the vehicle speed suppression control is control of decelerating the vehicle when the speed of the vehicle is higher than the vehicle speed threshold value.

7. The collision avoidance assistance device for a vehicle according to claim 2,
wherein the driving force increase operation is an operation for increasing an operation amount of an accelerator pedal, and
wherein the control device is configured to determine that the erroneous operation condition is satisfied in a case in which the operation amount of the accelerator pedal is equal to or larger than a threshold value when the speed of the vehicle is equal to or lower than a vehicle speed threshold value.

8. The collision avoidance assistance device for a vehicle according to claim 2, wherein the vehicle speed suppression control is control of setting a driving force output by an internal combustion engine being the driving force source of the vehicle to a driving force at idling when the speed of the vehicle is equal to or lower than a vehicle speed threshold value.

9. The collision avoidance assistance control device for a vehicle according to claim 2, wherein the vehicle speed suppression control is control of setting the driving force output by the driving force source of the vehicle to a driving force which allows a state in which the vehicle is stopped on an inclined road surface to be maintained when the speed of the vehicle is equal to or lower than a vehicle speed threshold value.

10. The collision avoidance assistance control device for a vehicle according to claim 2, wherein the vehicle speed suppression control is control of decelerating the vehicle when the speed of the vehicle is higher than a vehicle speed threshold value.
